(19) United States
(12) Patent Application Publication
(10) Pub. No.: US 2013/0080204 A1
(43) Pub. Date: Mar. 28, 2013

(54) DYNAMIC MEETING LOCATION DETERMINATION

(71) Applicants: Behrooz Khorashadi, Mountain View, CA (US); Saumitra Mohan Das, San Jose, CA (US); Lionel Jacques Garin, Palo Alto, CA (US); Eric K. Holm, San Jose, CA (US); Ayman Fawzy Naguib, Cupertino, CA (US); Niccolo A. Padovani, San Diego, CA (US)

(72) Inventors: Behrooz Khorashadi, Mountain View, CA (US); Saumitra Mohan Das, San Jose, CA (US); Lionel Jacques Garin, Palo Alto, CA (US); Eric K. Holm, San Jose, CA (US); Ayman Fawzy Naguib, Cupertino, CA (US); Niccolo A. Padovani, San Diego, CA (US)

(73) Assignee: QUALCOMM INCORPORATED, San Diego, CA (US)

(21) Appl. No.: 13/243,616

(22) Filed: Sep. 23, 2011

(51) Int. Cl. G06Q 10/00

(52) U.S. Cl. 705/7.19

(57) ABSTRACT

A method for dynamically selecting a meeting location for a plurality of meeting participants includes receiving a position of each meeting participant. The method also includes identifying one or more potential meeting location(s) based on the positions. The method further includes informing the meeting participants of the one or more potential meeting location(s). Furthermore, the method includes determining the meeting location, from the one or more potential meeting location(s), based on input from the meeting participants.

### TECHNICAL FIELD

The present teachings relate, in general, to position location and, more particularly, to establishing meeting locations for mobile device users.

### BACKGROUND

A type of social interaction increasingly encountered among users of mobile phones involves deciding where to meet. Often the decision occurs on the spot by wireless instant messaging, texting or voice, commonly employing mobile devices such as cell phones. For instance, friends may communicate with each other through text messages to determine they are in the same mall or plan to meet later at a mall. The friends can then decide to meet at a restaurant at that mall. However, there are multiple locations in the mall that satisfy the description of a potential meeting place (e.g., restaurant) and each party may have a different preference. Eventually the parties may agree on a common meeting place favored by the majority. However, this process is not automated and is time consuming.

### BRIEF SUMMARY

Various representative aspects of the present teachings are directed to establishing meeting locations that are conveniently located for meeting participants, based on their determined position. The establishment of a meeting location may take into account the proposed activity for the meeting and participant preferences.

According to some aspects of the disclosure, a method for dynamically selecting a meeting location for meeting participants includes receiving a position of each meeting participant. The method also includes identifying one or more potential meeting location(s) based on the positions. The method may further include informing the meeting participants of the potential meeting location(s). Furthermore, the method includes determining the meeting location, from the potential meeting location(s), based on input from the meeting participants.

According to some aspects of the disclosure, an apparatus for dynamically selecting a meeting location for meeting participants includes means for receiving a position of each meeting participant. The apparatus also includes means for identifying one or more potential meeting location based on the positions. The apparatus may further include means for informing the meeting participants of the potential meeting location(s). Furthermore, the apparatus includes means for determining the meeting location, from the potential meeting location(s), based on input from the meeting participants.

According to some aspects of the disclosure, an apparatus for dynamically selecting a meeting location for meeting participants includes a memory and one or more processors coupled to the memory. The processor(s) is configured to receive a position of each meeting participant. The processor(s) is also configured to identify one or more potential meeting location based on the positions. The processor(s) is further configured to inform the meeting participants of the potential meeting location(s). Furthermore, the processor(s) is configured to determine the meeting location, from the potential meeting location(s), based on input from the meeting participants.

According to some aspects of the disclosure, a computer program product for dynamically selecting a meeting location for meeting participants includes a computer-readable medium having non-transitory program code recorded thereon. The program code includes program code to receive a position of each meeting participant. The program code also includes program code to identify one or more potential meeting location(s) based on the positions. The program code further includes program code to inform the meeting participants of the potential meeting location(s). Furthermore, the program code includes program code to determine the meeting location, from the potential meeting location(s), based on input from the meeting participants.

The foregoing has outlined rather broadly the features and technical advantages of the present teachings in order that the detailed description that follows may be better understood. Additional features and advantages will be described hereinafter, which form the subject of the claims. It should be appreciated by those skilled in the art that the conception and specific aspects disclosed may be readily utilized as a basis for modifying or designing other structures for carrying out the same purposes of the present teachings. It should also be realized by those skilled in the art that such equivalent constructions do not depart from the technology of the teachings as set forth in the appended claims. The novel features which are believed to be characteristic of the present teachings, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present teachings.

### BRIEF DESCRIPTION OF THE DRAWINGS

For a more complete understanding of the present teachings, reference is now made to the following description taken in conjunction with the accompanying drawings.

FIGS. 1-5 show a layout of a portion of a mall depicting potential meeting participants at various stages of arranging a meeting location, in accordance with one aspect of the present disclosure.

FIG. 6 is a block diagram illustrating an exemplary process for setting up a meeting location, in accordance with one aspect of the present disclosure.

FIG. 7 shows an exemplary Global Satellite Navigation System (GNSS), which may be employed to implement a Position Determination System (PDS) receiver in a mobile communication device in accordance with one aspect of the present disclosure.

FIG. 8 illustrates an exemplary computer system, which may be employed to implement a PDS receiver, according to certain aspects of the present disclosure.

FIG. 9 is a block diagram illustrating an exemplary method or process for dynamically selecting a meeting location for multiple meeting participants.

### DETAILED DESCRIPTION

The process of defining a meeting location may be simplified and made more efficient by monitoring the positions of the meeting participants. Position determination systems (PDSs) can help locate the meeting participants, and can include a number of ground and/or space-based navigational systems. Ground-based systems, such as the OMEGA navigation system, the Russian Alpha system, the Long Range Navigation (LORAN) system, and the like each use terrestrial radio signals for establishing position. PDSs also include satellite positioning systems (SPSs) and Global Navigation Satellite Systems (GNSS), such as Global Positioning System (GPS), Galileo, Glonass and BeiDou. SPSs, such as GPS, use a constellation of between 24 and 32 medium Earth orbit satellites that transmit precise radio frequency (RF) signals that allow SPS receivers to determine their current location, the time, and their velocity. An SPS receiver follows a positioning process to calculate its position by carefully timing the signals sent by three and preferably four or more of the constellation of SPS satellites. PDSs can also include any ground based or indoor positioning technology, e.g., either based on RF signals such as WiFi or UWB, or on inertial sensors such as accelerometers, gyrometers, barometric sensors, or magnetic sensors.

Each satellite continually transmits messages containing the time the message was sent, a precise orbit for the satellite sending the message, i.e., the ephemeris, and the general system health and rough orbits of all SPS satellites, i.e., the almanac. These signals essentially travel at the speed of light through space and slightly slower through the Earth's atmosphere. The timing of each signal can be used to calculate the distance to each satellite thereby establishing that the SPS receiver is approximately on the surfaces of spheres centered at each satellite. The SPS receiver also uses, when appropriate, the knowledge that the SPS receiver is on or near the surface of a sphere representative of the Earth. This information is then used to estimate the position of the SPS receiver as the intersection of sphere surfaces. The resulting coordinates are converted to a more convenient form for the user such as latitude and longitude, or location on a map, and then displayed.

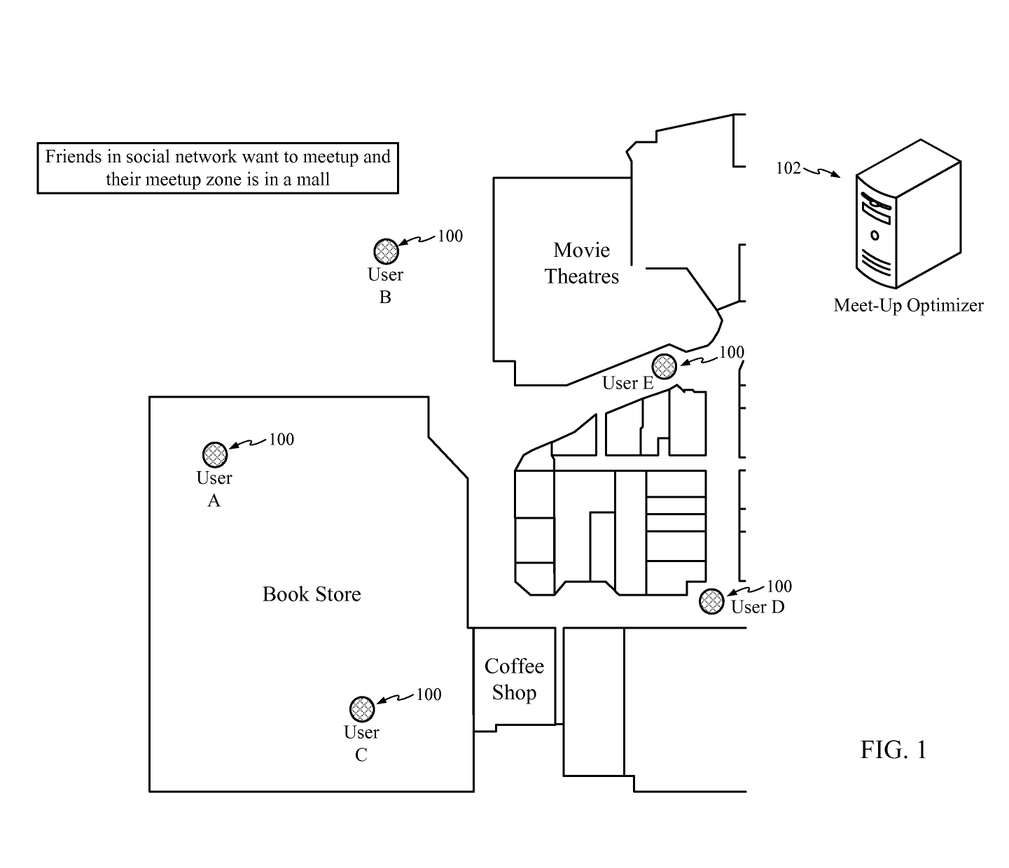

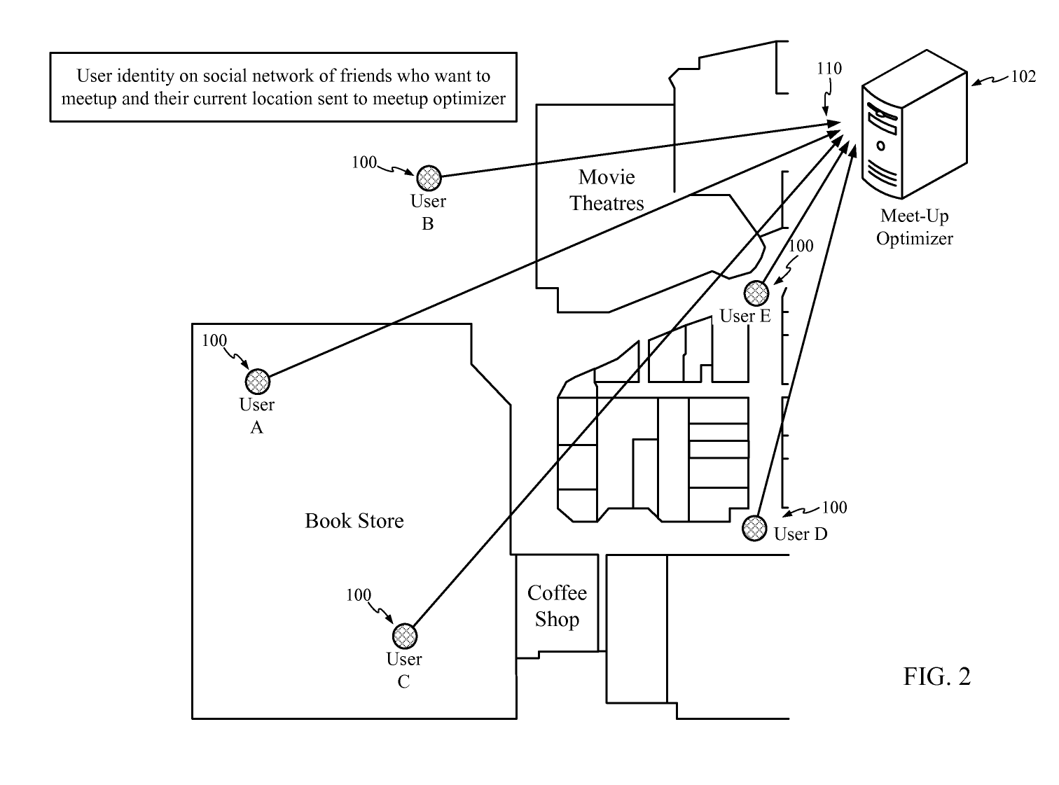

FIG. 1 shows a layout of a mall with five friends 100 of a social network located at various positions in the mall. The friends may, as a result of communicating with each other, e.g., by cell phone (voice or text messaging) determine they are in a common area, or through prior communications, e.g., using a social network such as Facebook, arrange to be in the common area. According to an aspect of the disclosure, in order to meet up in a specific meeting location, one of the friends defines the participants or selects a predefined social group that defines the participants using his or her mobile device configured in accordance with the present disclosure. In particular, the mobile devices of the friends each include a position determination system (PDS) and are in communication with a meet-up optimizer 102, which may be implemented as a server with a database for storing user (participant) and group information. As shown in FIG. 2, the identity of all meeting participants and their current positions are sent to the meet-up optimizer 102. A meeting time can also be provided. Optionally, an activity type (e.g., dinner, movie, shopping, etc.) is provided.

The meet-up optimizer 102, in one aspect, determines a potential movement zone for each friend (participant) 100 based on a proposed meeting time. The potential movement zone is the distance in any direction that a participant can cover from his or her present position in the time interval between the present time and the meeting time. The movement zone can be determined by estimating the speed of the user. In one example, a movement zone is a shape defined in every 10 degree direction with a routable area defined with time to travel as (time to event−the current time).

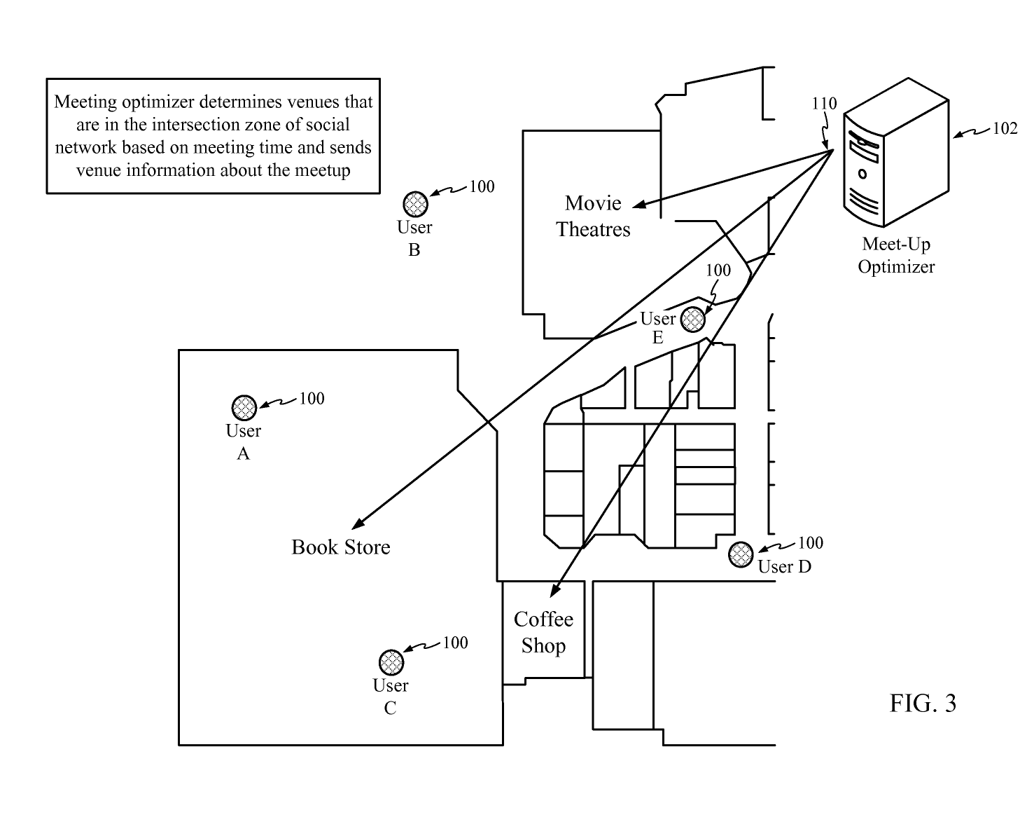

The meet-up optimizer 102 can define a meeting zone by determining the overlap of the potential movement zones of the participants. As shown in FIG. 3, the meet-up optimizer determines venues (potential meeting locations) within the meeting zone. If an activity type was selected, the potential meeting locations can be pruned accordingly. The meet-up optimizer 102 then sends the venue information to the participants.

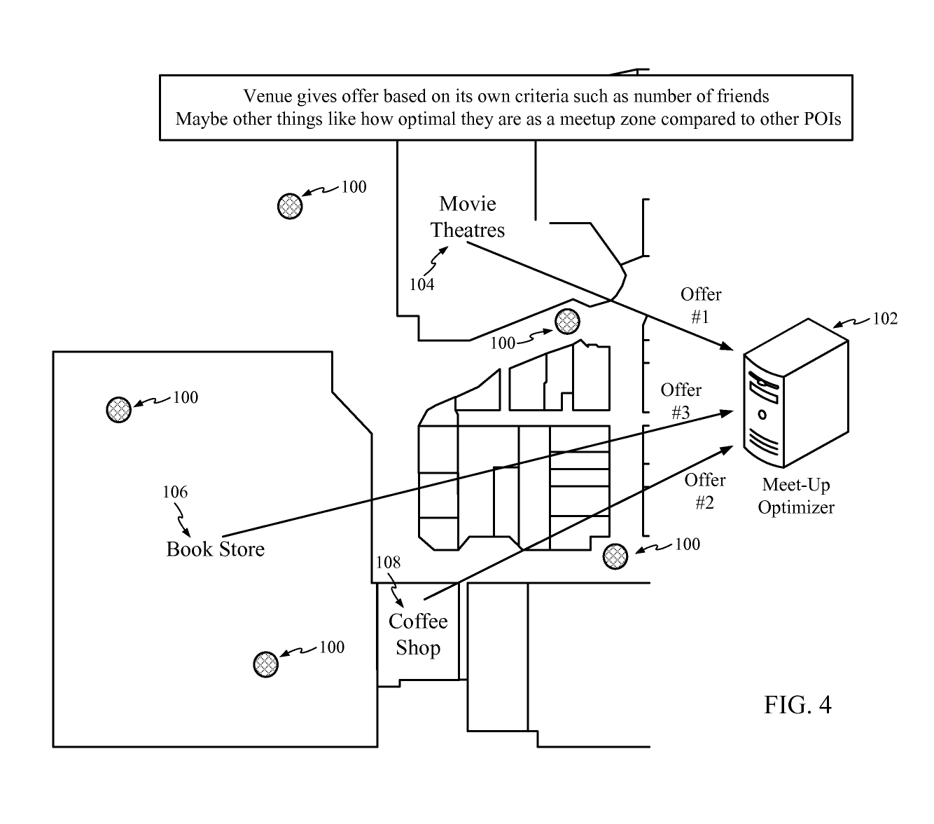

In another aspect, the meet-up optimizer 102 also communicates the potential meeting to the potential meeting locations, e.g., retailers present in meeting locations. In one aspect the potential meeting locations may be provided not only with the existence of a potential meeting and its purposes (such as dining or shopping) but also with the number of participants, and the number of competitors under consideration and the relative proximity of the various competitor venues to the participants of the meeting. By informing the competitors of the rank in terms of optimal distance for meet-up, the competitors may have incentives to provide a better offer. For example, a coffee shop in the meeting zone may be informed it is a little out of the way and the coffee shop may thus provide a better offer than if the coffee shop was at the best location for meet-up. Another factor that may affect the offer is the number of meeting participants. The participant information may be anonymonized before being sent to the potential meeting locations. The number of participants as well as some of their metadata such as the activity being considered, age range of the participants, and/or gender can be included in the information sent to the potential meeting location so they can decide what type of offer to make. The various potential meeting locations (competitor venues) 104, 106, 108 provide their offers or incentives (e.g., coupons) to the meet-up optimizer 102 as shown in FIG. 4. The venue may put a condition on the offer, for example, that it will only be valid if all the participants show up.

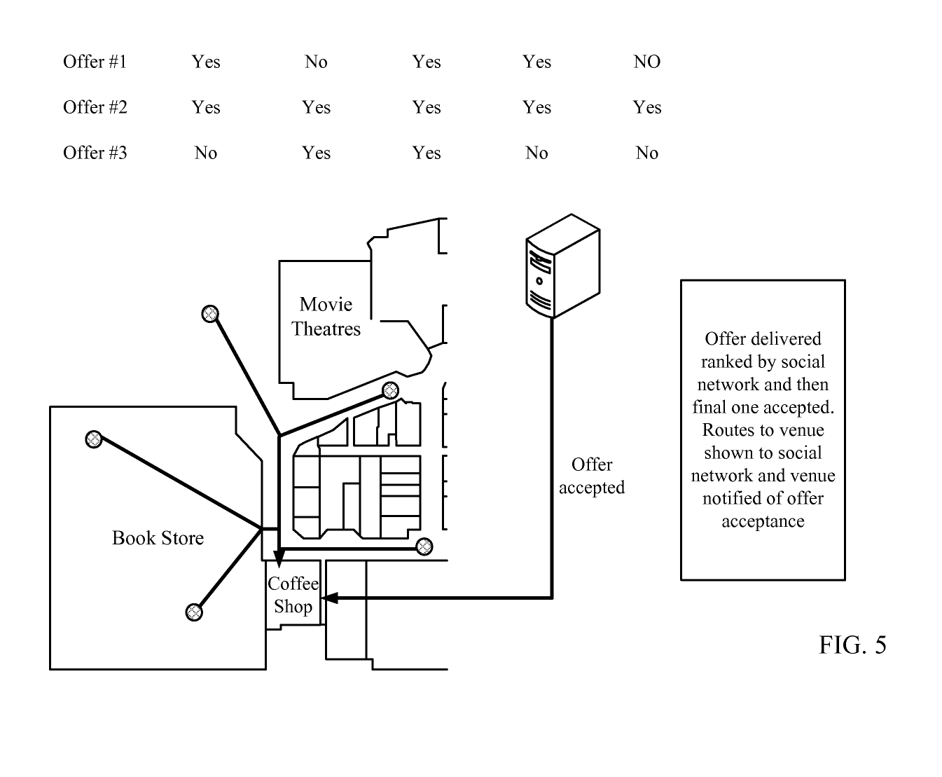

In the example shown in FIG. 5, the five participants vote on each of the three offers. In one aspect, the participants 100 submit their votes to the meet-up optimizer 102, which determines the winning venue. In another aspect, the initiating participant submits the winning venue to the meet-up optimizer 102. The meet-up optimizer 102 notifies the winning venue of the accepted offer or selection. In one aspect, the winning venue is charged a fee. The meet-up optimizer 102 can then display the winner at the participant mobile device, ask for confirmation and deliver meet up time and directions to the winning venue.

In the above example, one of the users defined the meeting participants. However, the meet-up optimizer may initiate a meeting by identifying two or more users in the same location, e.g., in a mall or within a predefined distance or travel time of each other. In such a situation, the meet-up optimizer can notify one or both users that they are in a similar location and may offer them the option of having the meet-up optimizer 102 determine potential meeting locations.

The present disclosure provides a method for participants wishing to get-together at a mutually convenient place to have their locations determined and have one or more meeting locations identified based on the preferences and locations of the participants. For example, “friends” on a social network site may be recognized as being in the vicinity of each other and then offered the opportunity to meet at a coffee shop and receive a free drink size upgrade. In addition, the present disclosure allows for the competition among the venues for the participants' business by allowing them to bid on incentives prior to the decision by the participants.

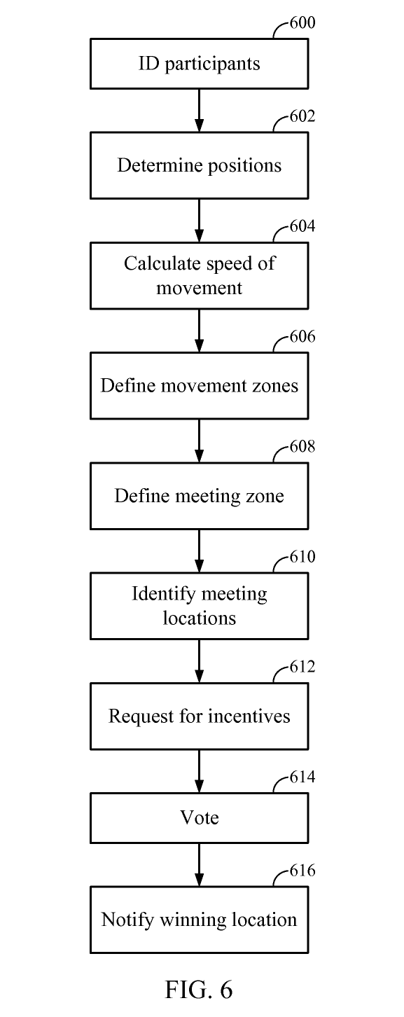

An exemplary process is shown in FIG. 6. At block 600, the initiating participant identifies the meeting participants to the meet-up optimizer. The meet-up optimizer determines the position or location of each participant (Block 602). Using the identities of the participants and their positions, the meet-up optimizer determines the speed of movement for each participant (taking into account things like demographic information, e.g., age of the participant; the time of day; the amount of congestion typically found in the particular location of the participant for that time of day, the mode of transportation of the participant, bike, car, walking, etc.) (Block 604). Based on the speed of movement of each participant, the meet-up optimizer defines a movement zone (distance that can be covered in each direction) for each participant (Block 606). In block 608, the meet-up optimizer defines a meeting zone base on overlaps of the movement zones of the participants. Using a database of meeting locations (points of interest (POIs)) that could serve as potential meeting locations and any other information received from the users (user preferences) and their demographic profiles (defining user preferences), the meet-up optimizer determines the potential meeting locations for the participants (Block 610). The meet-up optimizer then submits these results to potential meeting locations with a request for incentives or offers to entice the participants to their locations (Block 612). The incentives received from the meeting locations are forwarded to the participants for a vote (Block 614). The meet-up optimizer then determines the winner from the participant votes and notifies the winning meeting location that their offer is accepted (Block 616).

In one aspect, the mobile communications device can be implemented as a location aware social networking application on top of a couponing engine, such as Firethorn. The social networking application, such as Facebook, provides a platform for capturing user information (demographics) and may be configured to allow users to define social groups. This allows an initiating participant in a proposed meeting to work from pre-defined social groups and to create a subset for a particular meeting. For instance, a participant may have a predefined a list of friends having a common interest but may want to arrange a meeting with only some of these friends and may therefore define a subset. The meet-up optimizer may also be configured to adjust the participants of a proposed meeting group based on their distance or travel time. Thus, the meet-up optimizer may eliminate one or more participants whose movement zone does not overlap with the movement zones of the other participants, thereby establishing a redefined group.

In one aspect, the meet-up optimizer includes an application for determining a weighting factor for each potential meeting location. Each weighting factor may include the distance of each participant of the group or subset or redefined group to each of the potential meeting locations, information specific to the meeting, and demographic information of the participants. This weighting factor may be presented to the potential meeting locations in seeking incentives or offers from the various meeting locations.

Although the preceding description characterized the meet-up optimizer as a server, in one aspect the meet-up optimizer is an application executing on one of the participant mobile devices.

Although the preceding description related to identifying a meet up zone when all participants are in a mall or somewhere in close proximity to each, other techniques for identifying a meeting location are also contemplated for other scenarios. For example, an online flash meeting of people who do not know each other, and decide to meet “somewhere” at the spur of the moment is considered. The meeting place can be dynamically defined as the weighted center of mass of the location of all potential people to meet. Other mathematical algorithms can be used as an alternative, depending on the goal to be achieved. The goal can be reducing or minimizing the overall distance to cover among participants, or reducing or minimizing the distance to cover for a limited number of participants, or the fastest time to meet, or even reducing/minimizing the number of laggards who will never reach the meeting point, because of their slowness This solution can also work in the case of participants exhibiting widely varying velocities (e.g., some of them walking, some of them driving, or even using mass transportation). It can also include a criterion to eliminate the “outliers”, i.e. “supposed participants” that actually move away from the dynamic meeting point, and whose location should be ignored in the final meeting point, with the risk of jeopardizing the meeting point convergence if not done.

The relative weight of the location of each participant when determining the meeting point (i.e., how much the current location can pull the location of the meeting point) can be varied, depending on the stationarity of the user (assuming they are stationary at a point of high interest and do not want to move) or by his/her level of excitation. For example, analyzing message content (e.g., “Come see what I have found”) may help determine excitation level. This strategy promotes a faster convergence, and reduces or minimizes the distance to cover for the participants farthest from the meeting point. In yet another aspect, if one of the potential meeting attendees does not plan on attending the meeting (or can never agree with others on where to meet), this potential attendee can unfairly influence the meeting location selection and can be eliminated from the calculations.

An underlying premise of the present disclosure is that the locations or positions of the meeting participants can be determined. In one aspect, the positions of the participants are determined by position determination systems (PDS) in mobile communication devices such as cell phones. The PDS may include any number of ground and/or satellite-based positioning systems. For example, it may include a Global Navigation Satellite Systems (GNSS), such as Global Positioning System (GPS), Galileo, Glonass and BeiDou. It can also include any ground based position determination system, or indoor location system, as noted above.

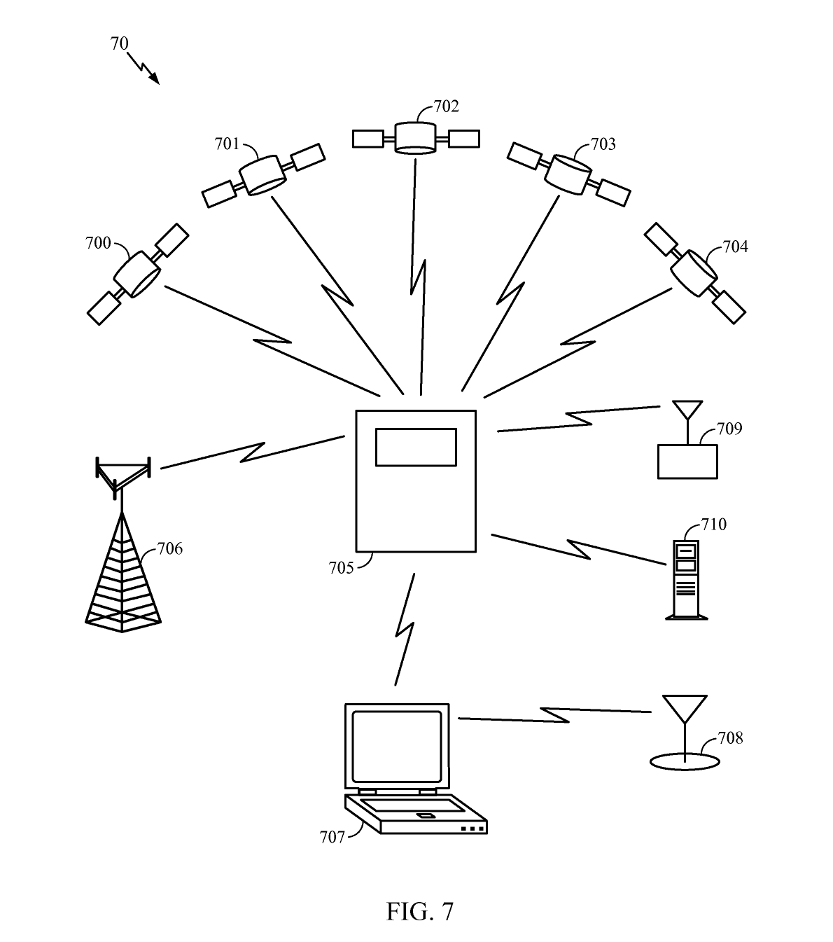

FIG. 7 shows a block diagram of an SPS system 70 according to one aspect of the present teachings. The SPS system 70 includes various satellites. As illustrated in FIG. 7, satellites 700-704 are shown as a part of the SPS system 70. However, some of the satellites 700-704 may actually belong to additional systems. They may be used together, as a part of the SPS system 70, for various purposes.

A mobile device 705 is configured to acquire, receive, and process the signals from the satellites 700-704, which may be from an SPS, such as a GPS, Galileo, GLONASS, GNSS, a system that uses satellites from a combination of these systems, or any SPS developed in the future. This SPS/PDS positioning process begins with the mobile device 705 searching for location data from alternative sources, such as a cell site 706, a laptop computer 707, and a wireless transmitter 709. The transmitter 709 could include any number of various transmitters, such as BLUETOOTH™ transmitters, an 802.11x wireless access point, a femtocell, a transponder device, a digital television (DTV) transmitter, a commercial radio transmitter (e.g., FM or AM radio), and the like. In some cases, the location data is converted to an actual location. In other cases, the location data itself, rather than the actual location is used. For example, a time difference of arrival (TDOA) between two cell sites measurement may be received and used.

The mobile device 705 can establish communication with the cell site 706 in either uni- or bi-directional communication. The mobile device 705 and the cell site 706 may provide various forms of location data, such as the mobile country code (MCC), the cell identifier (ID), which would enable a lookup of the location of the cell in a base station almanac, latitude, longitude and altitude. The latitude, longitude and altitude of the cell may be used as a seed location or combined with the location from other transceivers as well as timing and/or signal strength information to calculate a seed location of the mobile device. In uni-directional communication, the mobile device 705 receives at least the cell ID. During bi-directional communication, the mobile device 705 will receive at least the MCC and the cell site ID. The information received during bi-directional communication is highly reliable because the identities of the mobile device 705, the cell site 706, and the network that operates over the cell site 706 are verified. In this case, the location of the base stations and transceivers may be verified for accuracy via bi-directional communication.

The methodologies described herein may be implemented by various techniques depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. Although the communication apparatus may not store all of the instructions and/or data on a computer readable medium,

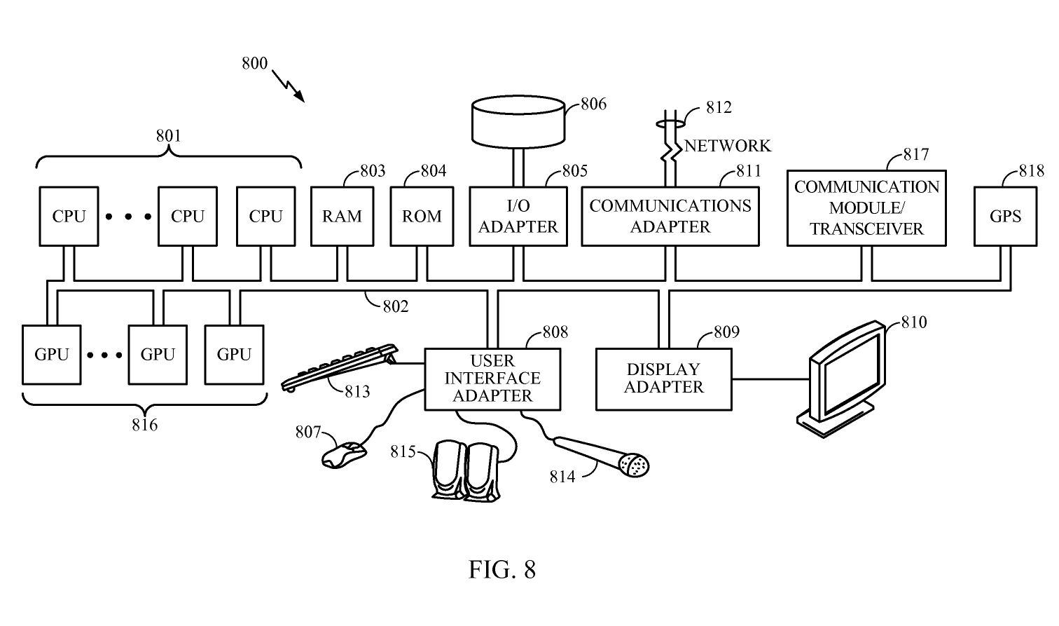

FIG. 8 illustrates an exemplary computer system 800, which may be employed to implement a PDS receiver or the meet-up optimizer according to certain aspects. A central processing unit (“CPU” or “processor”) 801 is coupled to a system bus 802. The CPU 801 may be any general-purpose processor. The present disclosure is not restricted by the architecture of the CPU 801 (or other components of exemplary system 800) as long as the CPU 801 (and other components of system 800) supports the operations as described herein. As such, the CPU 801 may provide processing to the system 800 through one or more processors or processor cores. The CPU 801 may execute the various logical instructions described herein. For example, the CPU 801 may execute machine-level instructions according to the exemplary operational flow described above in conjunction with FIG. 6. When executing instructions representative of the operational blocks illustrated in FIG. 6, the CPU 801 becomes a special-purpose processor of a special purpose computing platform configured specifically to operate according to the various aspects of the teachings described herein.

The computer system 800 also includes random access memory (RAM) 803, which may be SRAM, DRAM, SDRAM, or the like. The computer system 800 includes read-only memory (ROM) 804 which may be PROM, EPROM, EEPROM, or the like. The RAM 803 and ROM 804 hold user and system data and programs, as is well known in the art.

The computer system 800 also includes an input/output (I/O) adapter 805, communications adapter 811, user interface adapter 808, and display adapter 809. The I/O adapter 805, user interface adapter 808, and/or communications adapter 811 may, in certain aspects, enable a user to interact with the computer system 800 in order to input information. A communication module/transceiver 817 provides radio frequency communication capabilities to the computer system 800. A GPS receiver 818 provides satellite-enabled positioning information to be obtained in various satellite positioning systems.

The I/O adapter 805 couples a storage device(s) 806, such as one or more of a hard drive, compact disc (CD) drive, floppy disk drive, tape drive, etc., to the computer system 800. The storage devices are utilized in addition to the RAM 803 for the memory requirements associated with performing the operations associated with the SPS receivers and meet-up optimizer configured according to various aspects of the present teachings. A communications adapter 811 is adapted to couple the computer system 800 to the network 812, which may enable information to be input to and/or output from the system 800 via the network 812 (e.g., the Internet or other wide-area network, a local-area network, a public or private switched telephony network, a wireless network, any combination of the foregoing). A user interface adapter 808 couples user input devices, such as a keyboard 813, a pointing device 807, and a microphone 814 and/or output devices, such as speaker(s) 815 to the computer system 800. A display adapter 809 is driven by the processor 801 or by a graphical processing unit (GPU) 816 to control the display on a display device 810, for example, to display the winning venue. A GPU 816 may be any of a various number of processors dedicated to graphics processing and, as illustrated, may be made up of one or more individual graphical processors. A GPU 816 processes the graphical instructions and transmits those instructions to a display adapter 809. The display adapter 809 further transmits those instructions for transforming or manipulating the state of the various numbers of pixels used by the display device 810 to visually present the desired information to a user. Such instructions include instructions for changing state from on to off, setting a particular color, intensity, duration, or the like. Each such instruction makes up the rendering instructions that control how and what is displayed on the display device 810.

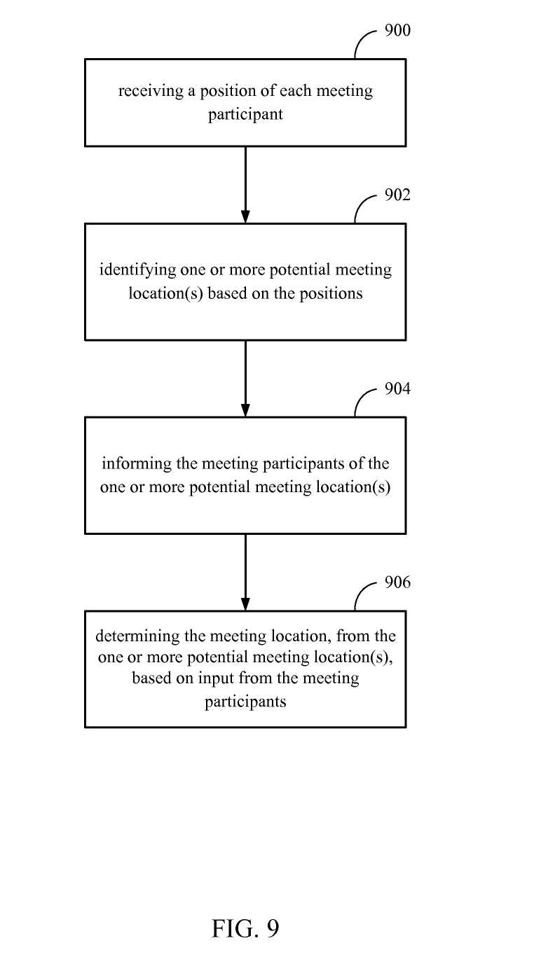

FIG. 9 is a block diagram illustrating a method or process for dynamically selecting a meeting location for a plurality of meeting participants. The process starts at block 900 by receiving a position of each meeting participant. At block 902, the process includes identifying at least one potential meeting location based on the positions. At block 904, the process includes informing the meeting participants of the at least one potential meeting location. The process ends at block 906 by determining the meeting location, from the at least one potential meeting location, based on input from the meeting participants.

In one configuration, the meet-up optimizer 102 and/or computer system 800 is configured for dynamically selecting a meeting location for a plurality of meeting participants including means for receiving a position of each meeting participant. In one aspect, the receiving means may be the meet-up optimizer 102, communication module transceiver 817, the communications adapter 811, the GPS 818, the CPU 801, the RAM 803 and/or the ROM 804 configured to perform the functions recited by the receiving means. The meet-up optimizer 102 and/or computer system 800 is also configured to include a means for identifying. In one aspect, the identifying means may be the meet-up optimizer 102, the CPU 801, the GPS 818, the RAM 803 and/or the ROM 804 configured to perform the functions recited by the identifying means. The meet-up optimizer 102 and/or computer system 800 is also configured to include a means for informing. In one aspect, the informing means may be the meet-up optimizer 102, communication module transceiver 817, the communications adapter 811, the GPS 818, the CPU 801, the RAM 803 and/or the ROM 804 configured to perform the functions recited by the informing means. The meet-up optimizer 102 and/or computer system 800 is also configured to include a means for determining. In one aspect, the determining means may be the meet-up optimizer 102, the CPU 801, the GPS 818, the RAM 803 and/or the ROM 804 configured to perform the functions recited by the determining means. In another aspect, the aforementioned means may be a module or any apparatus configured to perform the functions recited by the aforementioned means.

It shall be appreciated that the present disclosure is not limited to the architecture of the system 800. For example, any suitable processor-based device may be utilized for implementing the PDS or meet-up optimizer, including without limitation personal computers, laptop computers, computer workstations, multi-processor servers, and even mobile telephones. Moreover, certain aspects may be implemented on application specific integrated circuits (ASICs) or very large scale integrated (VLSI) circuits. In fact, persons of ordinary skill in the art may utilize any number of suitable structures capable of executing logical operations according to the aspects.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. A method for dynamically selecting a meeting location for a plurality of meeting participants, comprising:
receiving a position of each meeting participant;
identifying an at least one potential meeting location based on the positions;
informing the meeting participants of the at least one potential meeting location; and
determining a meeting location selection, from the at least one potential meeting location, based on input from the meeting participants.

2. The method of claim 1, further comprising:
seeking incentives from the at least one potential meeting location to influence the meeting location selection; and
informing the meeting participants of the incentives.

3. The method of claim 2, wherein seeking incentives includes informing the at least one potential meeting location of a number of meeting participants.

4. The method of claim 2, wherein seeking incentives includes informing the at least one potential meeting location of a plurality of competing potential meeting locations and rankings of the plurality of competing potential meeting locations.

5. The method of claim 2, wherein seeking incentives includes informing the at least one potential meeting location of an age range of the meeting participants and gender of the meeting participants.

6. The method of claim 2, wherein seeking incentives includes informing the at least one potential meeting location of a plurality of activities being considered by the meeting participants.

7. The method of claim 1, wherein the identifying comprises selecting the at least one potential meeting location to reduce at least one of an overall distance to be covered among all meeting participants, differences in distance to be covered for each meeting participant, and differences in travel time for each meeting participant.

8. The method of claim 7, wherein the identifying is based on, for each participant, at least one of: distance to each potential meeting location, and a time until a meeting.

9. The method of claim 1, wherein the identifying is based on an activity type specified by at least one of the meeting participants.

10. The method of claim 1, further comprising de-weighting a location of at least one of the meeting participants; and the identifying comprises identifying at least one potential meeting location while accounting for the de-weighted location.

11. The method of claim 9, wherein the de-weighting is based on the at least one of the meeting participants moving away from an identified meeting location, the method further comprising subsequently calculating a new meeting location after determining the at least one of the meeting participants is moving away.

12. The method of claim 9, wherein the de-weighting is based on the at least one of the meeting participants frequently voting differently from a majority of meeting participants, when the meeting participants are voting for the meeting location.

13. The method of claim 9, wherein the de-weighting is based on the at least one of the meeting participants being located a very large distance away from other meeting participants.

14. An apparatus for dynamically selecting a meeting location for a plurality of meeting participants, comprising:
means for receiving a position of each meeting participant;
means for identifying an at least one potential meeting location based on the positions;
means for informing the meeting participants of the at least one potential meeting location; and
means for determining the meeting location, from the at least one potential meeting location, based on input from the meeting participants.

15. An apparatus for dynamically selecting a meeting location for a plurality of meeting participants, comprising:
a memory; and
at least one processor coupled to the memory and configured:
to receive a position of each meeting participant;
to identify at least one potential meeting location based on the positions;
to inform the meeting participants of the at least one potential meeting location; and
to determine the meeting location, from the at least one potential meeting location, based on input from the meeting participants.

16. The apparatus of claim 15, wherein the at least one processor is further configured:
to seek incentives from the at least one potential meeting location to influence meeting location selection; and
to inform the meeting participants of the incentives.

17. The apparatus of claim 16, wherein the at least one processor is further configured to seek incentives by informing the at least one potential meeting location of a number of meeting participants.

18. The apparatus of claim 16, wherein the at least one processor is further configured to seek incentives by informing the at least one potential meeting location of a plurality of competing potential meeting locations and rankings of the plurality of competing potential meeting locations.

19. The apparatus of claim 16, wherein the at least one processor is further configured to seek incentives by informing the at least one potential meeting location of an age range of the meeting participants and gender of the meeting participants.

20. The apparatus of claim 16, wherein the at least one processor is further configured to seek incentives by informing the at least one potential meeting location of a plurality of activities being considered by the meeting participants.

21. The apparatus of claim 15, wherein the at least one processor is further configured to identify by selecting the at least one potential meeting location to reduce at least one of an overall distance to be covered among all meeting participants, differences in distance to be covered for each meeting participant, and differences in travel time for each meeting participant.

22. The apparatus of claim 21, wherein the at least one processor is further configured to identify based on, for each participant, at least one of: distance to each potential meeting location, and a time until a meeting.

23. The apparatus of claim 15, wherein the at least one processor is further configured to identify based on an activity type specified by at least one of the meeting participants.

24. The apparatus of claim 15, wherein the at least one processor is further configured to de-weight a location of at least one of the meeting participants; and to identify by identifying at least one potential meeting location while accounting for the de-weighted location.

25. The apparatus of claim 23, wherein the at least one processor is further configured to de-weight based on the at least one of the meeting participants moving away from an identified meeting location; and to subsequently calculate a new meeting location after determining the at least one of the meeting participants is moving away.

26. The apparatus of claim 23, wherein the at least one processor is further configured to de-weight based on the at least one of the meeting participants frequently voting differently from a majority of meeting participants, when the meeting participants are voting for the meeting location.

27. The apparatus of claim 23, wherein the at least one processor is further configured to de-weight based on the at least one of the meeting participants being located a very large distance away from other meeting participants.

28. A computer program product for dynamically selecting a meeting location for a plurality of meeting participants, comprising:
a computer-readable medium having non-transitory program code recorded thereon, the program code comprising:
program code to receive a position of each meeting participant;
program code to identify at least one potential meeting location based on the positions;
program code to inform the meeting participants of the at least one potential meeting location; and
program code to determine the meeting location, from the at least one potential meeting location, based on input from the meeting participants.
